(19) United States
(12) Patent Application Publication
(10) Pub. No.: US 2022/0331943 A1
(43) Pub. Date: Oct. 20, 2022

(54) BIT HOLDER FOR A POWER TOOL

(71) Applicant: MaxPerf LLC, Key West, FL (US)

(72) Inventor: Haik BABAIAN, Key West, FL (US)

(73) Assignee: MaxPerf LLC, Key West, FL (US)

(21) Appl. No.: 17/720,416

(22) Filed: Apr. 14, 2022

Related U.S. Application Data
(60) Provisional application No. 63/176,537, filed on Apr. 19, 2021.

(51) Int. Cl. B25F 5/02

(52) U.S. Cl. CPC B25F 5/029

(57) ABSTRACT

A storage device for quarter-inch hex shank bits used in a power tool, the storage device including a body having a plurality of holding bores extending along portions of the body; a magnet disposed in the body; a first magnetic inductor disposed at an end of the bore and in contact with a side of the magnet; a second magnetic inductor disposed at an end of the bore and in contact with an opposing side of the magnet; and a mounting bore extending through the body.

This application claims priority to U.S. Provisional Application No. 63/176,537, filed Apr. 19, 2021.

### SUMMARY OF THE INVENTION

The present invention generally relates to improvements in a storage device for quarter-inch hex shank bits used in a power tool, and consists of the combinations, constructions, and arrangement of parts, as hereinafter described and claimed.

### BACKGROUND OF THE INVENTION

A principal object of the present invention is to provide a bit storage device that is attachable to a power tool, and provides a user of the tool with a selection of bit types, and/or duplicates of bits for immediate use, in the event of a failed bit that has deteriorated or has become damaged. Typically, users of power tools that use quarter-inch hexagonal shank bits can benefit from storage of additional bits that is localized to the tool.

The following U.S. patents, which are herein incorporated by reference, describe and illustrate existing bit holders used with power tool devices: U.S. Pat. Nos. 7,073,417; 8,336,709; 9,701,008; 10,442,074.

Existing devices have disadvantages, however, due to the following:
they use friction or direct clamping to retain bits making bit insertion and removal more physically demanding. Clip and friction type holders require greater amounts of the user's attention and effort to remove and insert bits.
bits fall out of the devices due to interference from contaminants like dirt, debris, oil, water, etc.
bits fall out of the friction type devices where the friction is supplied by contact with rubber, silicon, plastic, or similar due to interference from lubricants and other contaminants common to the tool owner's work environment that decrease friction (oil, water, etc.).
the devices that use clip type bit retention place a requirement on the user of the tool to precisely place the bit atop the retention area and then press firmly and completely the bit into the clip to lock it in place. Tool users wearing gloves often must remove them to gain the dexterity needed to complete this procedure.
the devices have bits store closely together making it difficult or impossible to retrieve bits should the power tool's owner is wearing gloves.
the devices fail to remain attached to the power tool due to the use of clamps, adhesive, or adhesive tape.
the devices do not remain in place, spin out of position, or lose mounted orientation due to the absence of keyed attachment to the power tool. Un-keyed mounting allows the holder to rotate out of position making bit insertion and retrieval a moving target.
bits can be in line with power tool's handle which can interfere with the user's ability to grip the power tool. A user reaching for the power tool may not be able to grip the handle due to bits and/or bit holder obstructing the power tool's grip area.

The device of the invention provides the following improvements and advantages over the existing bit storage devices for power tools:

Inserted bits are retained with magnetism. A magnetic field is established using magnet(s) and one or more inductive elements that transfer the magnetic field to the bit(s). The inductive elements also function as mechanical isolation that helps to protect the magnet(s). The combined magnet(s) and one or more inductive elements form a magnetic assembly that is more durable than magnet(s) alone providing longer service life in work environments.

The device of the invention attaches with a screw to the tool's manufacturer provided accessory internal threaded mount.

The device of the invention holds a quantity of up to four 1 inch (25 mm) and/or 2 inch (50 mm) long quarter-inch hex shank bits magnetically oriented in-line with the power tool's drive mechanism, and perpendicular to the power tool's handle while not blocking and not interfering with the power tool's detachable battery and its operation.

The device of invention that is cylindrical holds a quantity of up to eleven 1 inch (25 mm) long quarter-inch hex shank bits magnetically oriented in a radial array while not blocking and not interfering with the power tool's detachable battery and its operation.

Keyed mounting places the bit holder in a fixed position, eliminating random bit holder location and unwanted interference with the power tool's grip area and battery removal/replacement operation.

The device of the invention stores bits within bores that have a chamfered opening. The bores encase the sides of the bits providing partial housing, and the bore opening chamfer provides users with a widened entry area to facilitate efficient insertion of each bit.

The inventive device offers a quick, simple, and easy bit removal and insertion, and includes ample room between bits for users to grab bits without looking. The magnetic assembly secures bits.

Further features, objects and advantages of the invention will be noted as the construction and details of the invention are more fully hereinafter set forth.

### BRIEF DESCRIPTION OF THE DRAWINGS

FIG. 1 is a top left perspective external view of the bit holder of the invention.

FIG. 2 is a perspective top right external view of the bit holder.

FIG. 3 is a perspective bottom-left external view of the bit holder.

FIG. 4 is a top external view of the bit holder.

FIG. 5 is a bottom external view of the bit holder.

FIG. 6 is a front elevation external view of the bit holder.

FIG. 7 is a rear elevation external view of the bit holder.

FIG. 8 is a right elevation external view of the bit holder.

FIG. 9 is a left elevation external view of the bit holder.

FIG. 10 is a cutaway front (end) view of the bit holder showing internal body elements.

FIG. 11 is a cutaway perspective top-left view of the bit holder showing internal body elements shown.

FIG. 12 is a cutaway perspective top-right subsection view of the bit holder showing internal body elements.

FIG. 13 is a cutaway perspective top-left subsection view of the bit holder showing internal body elements.

FIG. 14 is a cutaway perspective top-left view of the bit holder showing reference-numbered internal body elements.

FIG. 15 is a bottom view of the bit holder showing internal body elements.

FIG. 16 is a perspective top-right view of the bit holder showing body elements.

FIG. 17 is a cutaway perspective top-left view of the bit holder showing internal component elements.

FIG. 18 is a cutaway front view of the bit holder showing internal component elements assembly sequence with component insertion steps noted in alphabetical order.

FIG. 19 is a front view of the bit holder installed (or mounted) on user's brand A power tool for both power tool's left and right side mounting locations.

FIG. 20 is a front view of the bit holder installed (or mounted) on user's brand B power tool for both power tool's left and right side mounting locations.

FIG. 21 is a front view of the bit holder installed (or mounted) on user's brand A power tool's right side mounting location.

FIG. 22 is a front view of the bit holder installed (or mounted) on user's brand B power tool's right side mounting location.

FIG. 23 is a perspective back-right external view of a second embodiment of the bit holder.

FIG. 24 is a perspective front-left external view of a second embodiment of the bit holder.

FIG. 25 is a perspective front external view of a second embodiment of the bit holder.

FIG. 26 is a cutaway perspective back-right external view showing internal components of a second embodiment of the bit holder.

FIG. 27A is a perspective front right view of the assembly tool.

FIG. 27B is a front view of the assembly tool.

FIG. 27C is a side view of the assembly tool.

FIG. 27D is a top view of the assembly tool.

FIG. 27E is a perspective front right external view of the assembly tool and bit holder (unassembled).

FIG. 27F is a perspective top front view of the assembly tool and bit holder (assembled).

FIG. 27G is a perspective top rear view of the assembly tool and bit holder (assembled).

FIG. 28 shows an embodiment of the bit holder having 1 magnet/1 inductor/1 bore (top view).

FIG. 29 shows an embodiment of the bit holder having 1 magnet/1 inductor/1 bore (top perspective view).

FIG. 30 shows an embodiment of the bit holder having 1 magnet/2 inductors/2 bores (top view).

FIG. 31 shows an embodiment of the bit holder having 1 magnet/2 inductors/2 bores (top perspective view).

FIG. 32 shows an embodiment of the bit holder having 1 magnet/1 inductor/2 bores (top view).

FIG. 33 shows an embodiment of the bit holder having 1 magnet/1 inductor/2 bores (top perspective view).

FIG. 34 shows an embodiment of the bit holder having 2 magnets/3 inductors/3 bores (top view).

FIG. 35 shows an embodiment of the bit holder having 2 magnets/3 inductors/3 bores (top perspective view).

FIG. 36 shows an embodiment of the bit holder having 1 magnet/2 inductors/4 bores (top view).

FIG. 37 shows an embodiment of the bit holder having 1 magnet/2 inductors/4 bores (top perspective view).

FIG. 38 shows an embodiment of the bit holder having 2 magnets/3 inductors/6 bores (top view).

FIG. 39 shows an embodiment of the bit holder having 2 magnets/3 inductors/6 bores (top perspective view).

FIG. 40 shows an embodiment (cylindrical) of the bit holder having 1 magnet/1 inductor/3 bores (top perspective view).

FIG. 41 shows an embodiment (cylindrical) of the bit holder having 1 magnet/1 inductor/3 bores (top perspective view).

FIG. 42 shows an embodiment (cylindrical) of the bit holder having 1 magnet/1 inductor/4 bores (top view).

FIG. 43 shows an embodiment (cylindrical) of the bit holder having 1 magnet/1 inductor/4 bores (top perspective view).

FIG. 44 shows an embodiment (cylindrical) of the bit holder having 1 magnet/2 inductors/7 bores (top view).

FIG. 45 shows an embodiment (cylindrical) of the bit holder having 1 magnet/2 inductors/7 bores (top perspective view).

FIG. 46 shows an embodiment (cylindrical) of the bit holder having 2 magnets/3 inductors/11 bores (top view).

FIG. 47 shows an embodiment (cylindrical) of the bit holder having 1 magnet/2 inductors/11 bores (top perspective view).

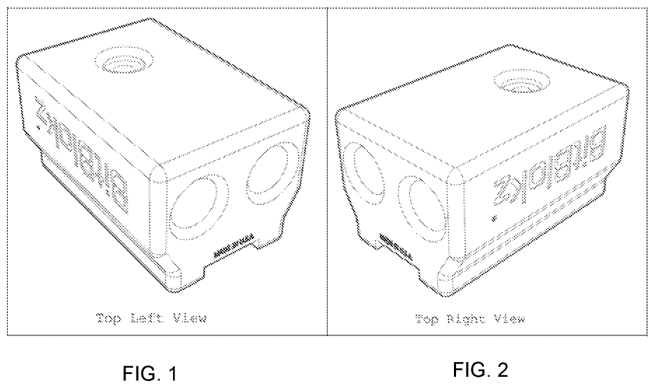

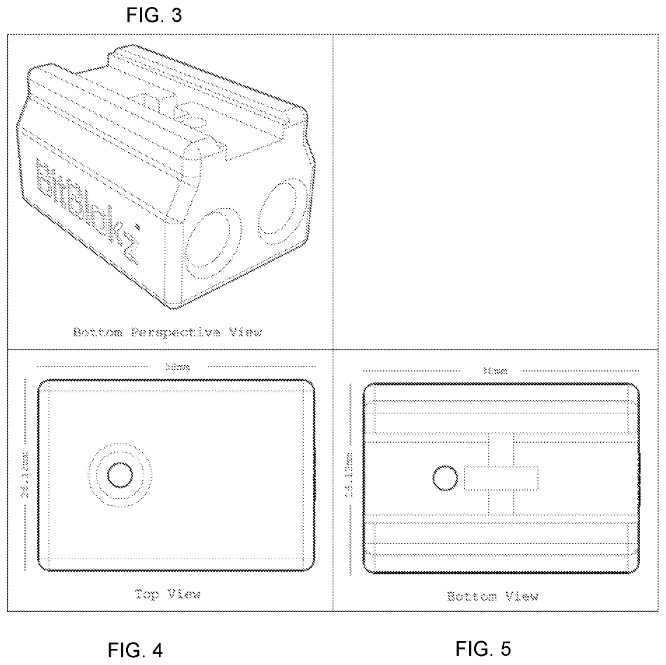

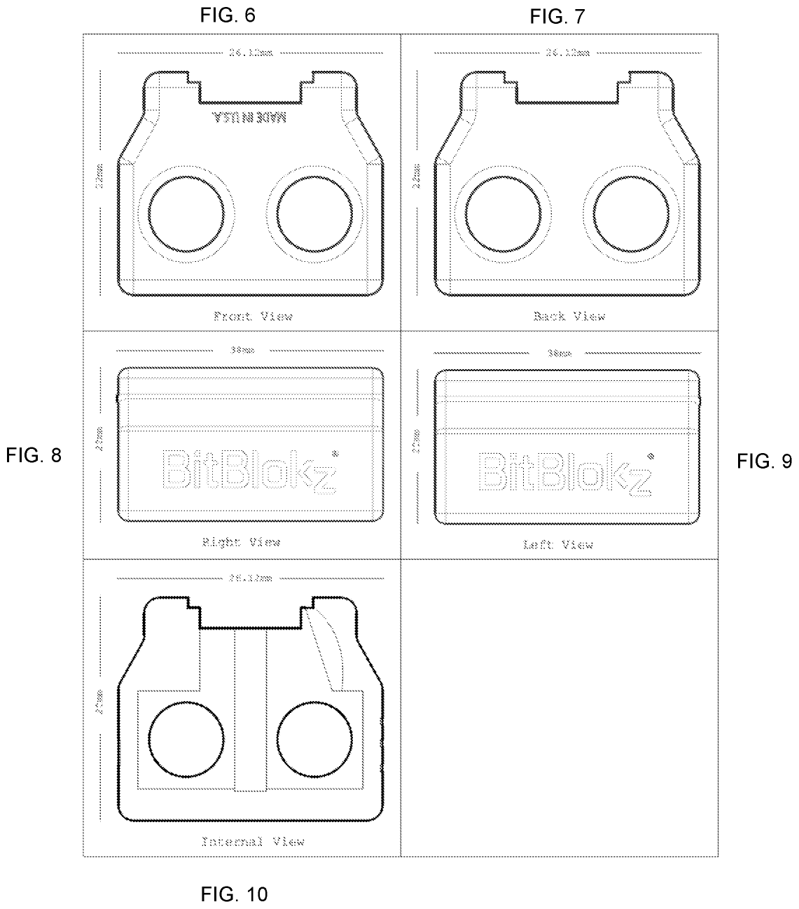

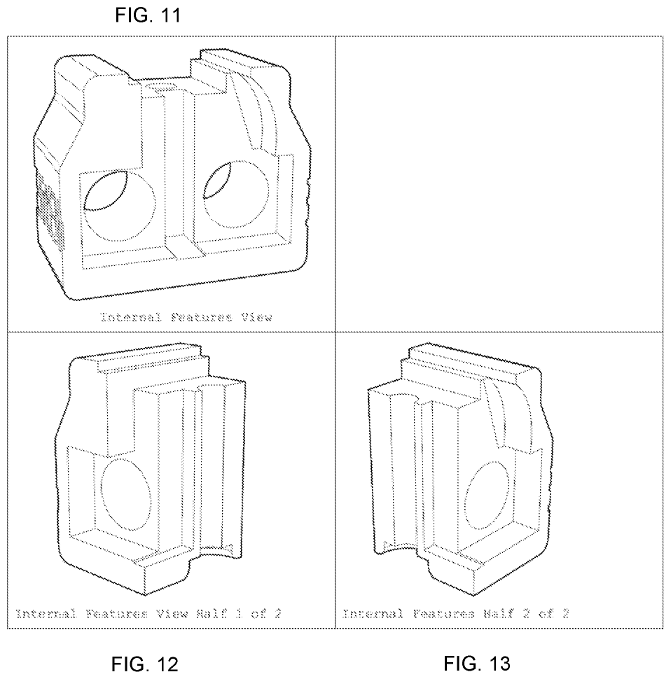

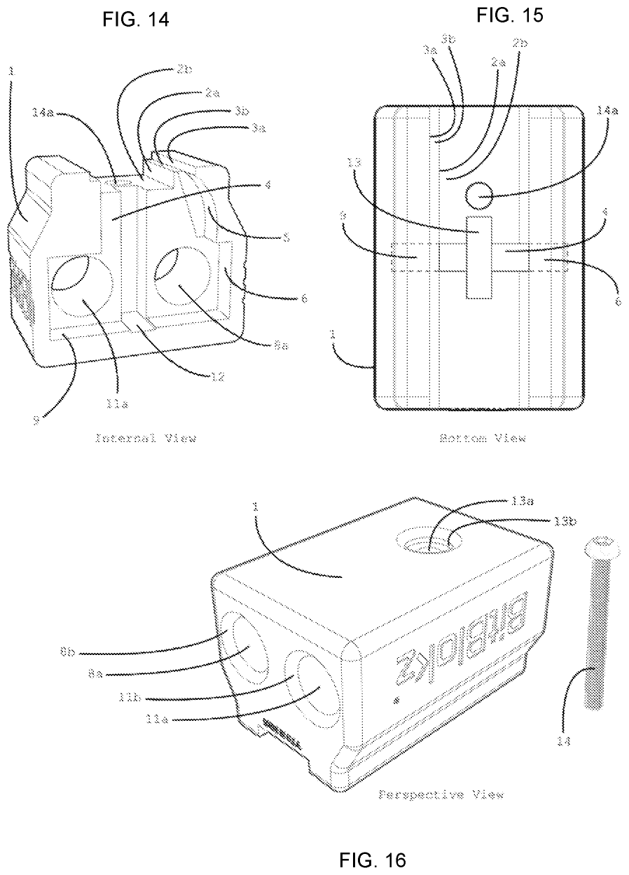

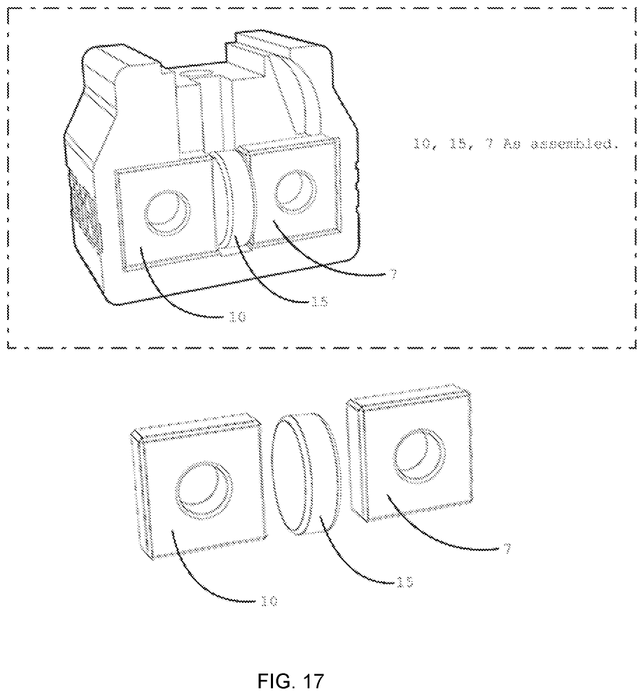

### DESCRIPTION OF THE PREFERRED EMBODIMENTS

Referring now more specifically to the drawings, the bit holder of the invention comprises the following components:
1. Body
2a. Mount 1 Wall, fits brand A
2b. Mount 1 Floor, fits brand A
3a. Mount 2 Wall, fits brand B
3b. Mount 2 Floor, fits brand B
4. Magnetic Inductor Insertion Channel
5. Magnetic Inductor 1 Chamber Trackway
6. Magnetic Inductor 1 Chamber
7. Magnetic Inductor 1
8a. Bore 1
8b. Bore 1 Chamfer
9. Magnetic Inductor 2 Chamber
10. Magnetic Inductor 2
11a. Bore 2
11b. Bore 2 Chamfer
12. Magnet Insertion Channel and Chamber
13a. Mounting Screw Bore
13b. Mounting Screw Counterbore with Fillet
14. Mounting Screw
15. Magnet

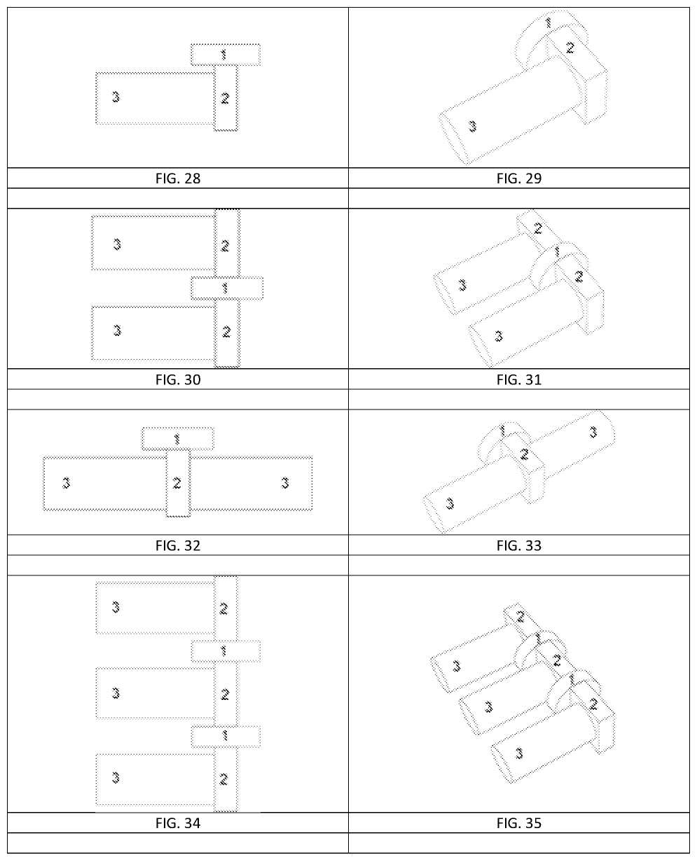

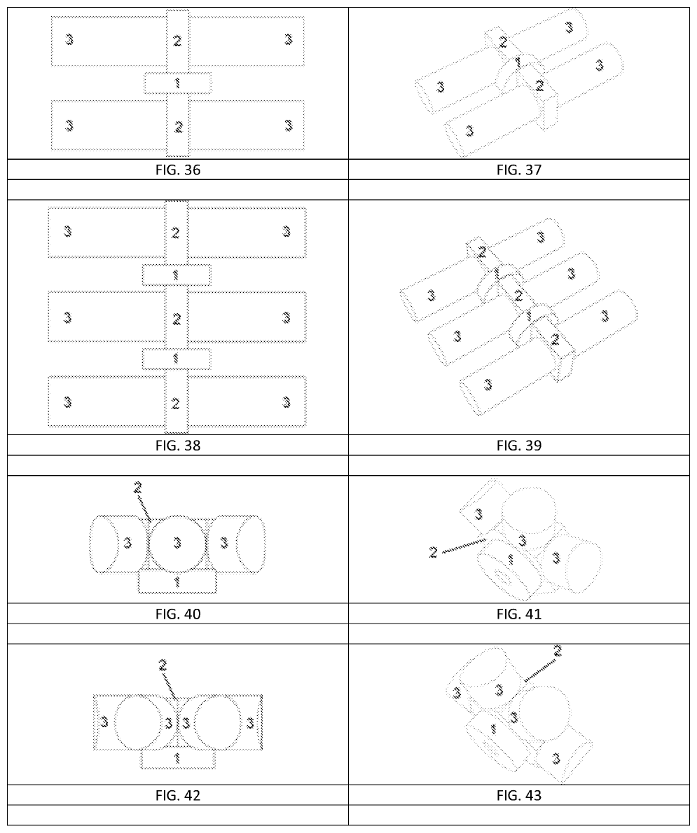

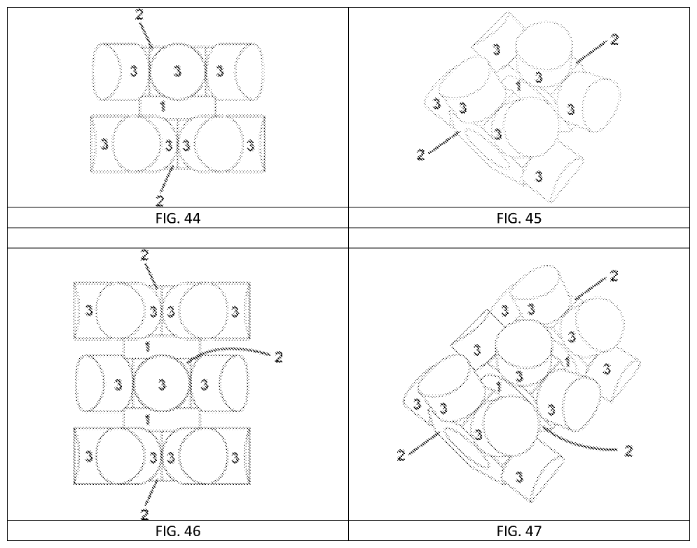

For FIGS. 28-47 only, the following reference numerals apply:
1. Magnet
2. Inductor
3. Bore

The main body (1) of the bit holder is preferably manufactured from a rigid thermoplastic or thermosetting polymer, and can also be manufactured using additive manufacturing techniques using known polymer injection molding techniques.

Production quality 3D-printing is also suitable for the manufacturing of the main body (1) and has the benefit of accommodating a variety of color choices that can aid in efficient visual identification of stored bit collections by supporting the use of color coding.

3-D printing methods are well known to a person of ordinary skill in the art, additional information being found at the following Internet links:

Learning 3D Printing (30 k foot level):
https://www.bcn3d.com/the-beginners-guide-to-3d-printing-6-steps/Learning
3D Printing (20 k foot level):
https://www.makerbot.com/learn/MIT
Overview video of technologies, value, etc. (less than 3 mins):
https://youtu.be/uFs-pgO8DmE
Somewhat basic, but has industry specific short reads and a patent reference:
https://www.explainthatstuff.com/how-3d-printers-work.html
More industry specific short reads:
https://3dprinting.com/what-is-3d-printing/General
types of 3D Printing:
https://www.businessworldit.com/3d-4d-technologies/types-of-3d-printing-technology/
More types, explanations:
https://www.techpats.com/3d-printing-technologies-overview/

The rendering of the material to its desired configuration can also be accomplished using conventional stock removal techniques with the utilization of CNC machining. It is also possible to machine the device from non-ferrous solid materials, such as bar stock aluminum alloy, non-magnetic metals, plastics, carbon fiber stock, or composites, including ceramic materials.

Die-casting is also possible as magnesium, and other non-ferrous alloys are commonly available for this manufacturing process.

The magnetic inductors (7, 10) are made of ferrous materials carbon steel and may be created from stock utilizing industrial punching (punch press) techniques, or other common machining techniques like milling or sawing.

The inductor may have a square shape, or a hexagonal shape, or any shape, such as a triangular shape, that offers a flat surface to make contact with a flat surface of the magnet.

The magnet (15) is a rare earth or neodymium magnet, but may be comprised of two (2) similar magnets that are arranged as a Halbach Array which is a geometrical configuration of permanent magnets on the basis of opposing geometrically linear assemblies for the generation of strong magnetic fields.

The magnet preferably is disc-shaped, having opposing flat surfaces to make contact with the inductor(s), but may be square-shaped, or any other shape that offers a flat opposing surface(s) to make contact with the inductor(s).

Magnetic inductors (7, 10) are made of ferrous materials carbon steel and may be created from stock utilizing industrial punching (punch press) techniques, or other common machining techniques like milling or sawing.

The body (1) contains all components and elements that are listed. Mount 1 (2a, 2b) together with mount 2 (3a, 3b) provide fitment for a variety of brands and models of power tools. 13a and 13b provide for mounting of the device with 14. 14 is recessed within 1 providing a low profile surface.

Elements 4, 5, 6, 9, and 12 combined form the component insertion and housing area. Components lock into place when final component magnet (15) is inserted. The volume of magnet (15), when installed, locks 7 and 10 within 6 and 9, respectively. Magnetic flux of 15 as applied to 7 and 10 provides the completion of the interlocking magnetic assembly within 6, 9, and 12 and completes the assembly of the bit holder.

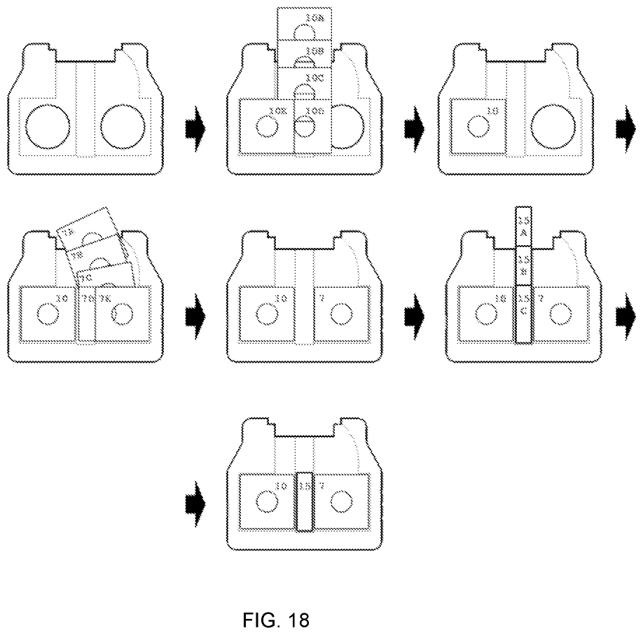

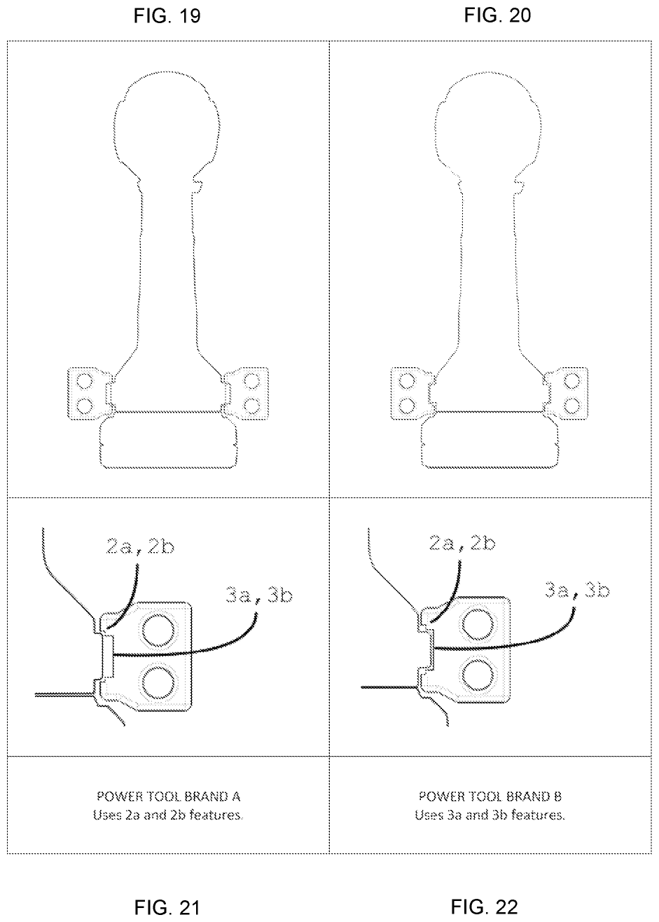

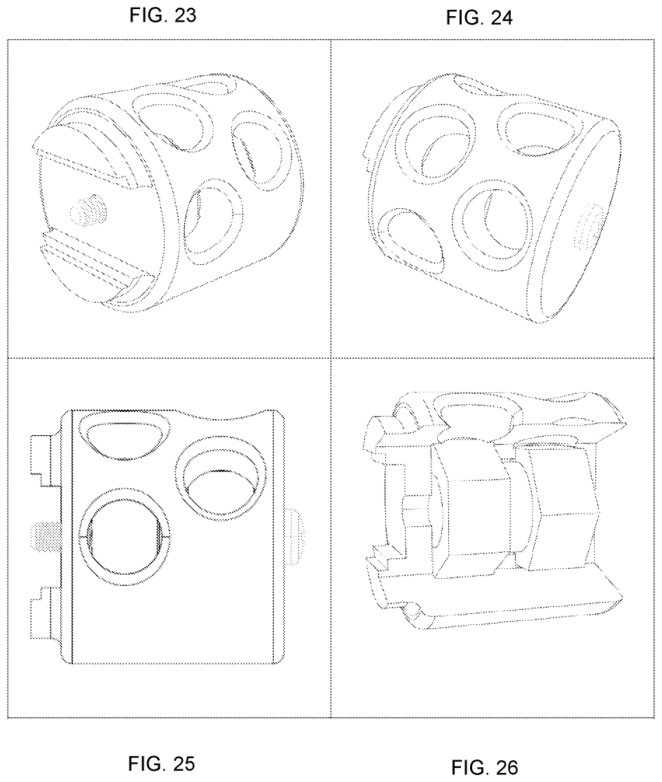

To assemble the bit holder, the following steps are carried out, with reference, in particular, to FIG. 18:

1. place the body on a flat work surface, bottom up with left side to the left.

2. insert magnetic inductor 2 (10) into magnetic inductor insertion channel (4) and slide (10) left into magnetic inductor 2 chamber (9).

3. insert magnetic inductor 1 (7) into magnetic inductor insertion channel (4) passing through magnetic inductor 1 chamber trackway (5) and slide (7) right into magnetic inductor 1 chamber (6).

4. hold in place the magnetic inductors (7 and 10) and insert magnet (15) into magnet insertion channel and chamber (12).

The magnet insertion channel and chamber (12) properly orients the magnet (15). The shape of the magnet (15) and the magnetic inductors (7 and 10) are individually bilaterally symmetrical having no unique orientation within the body (1).

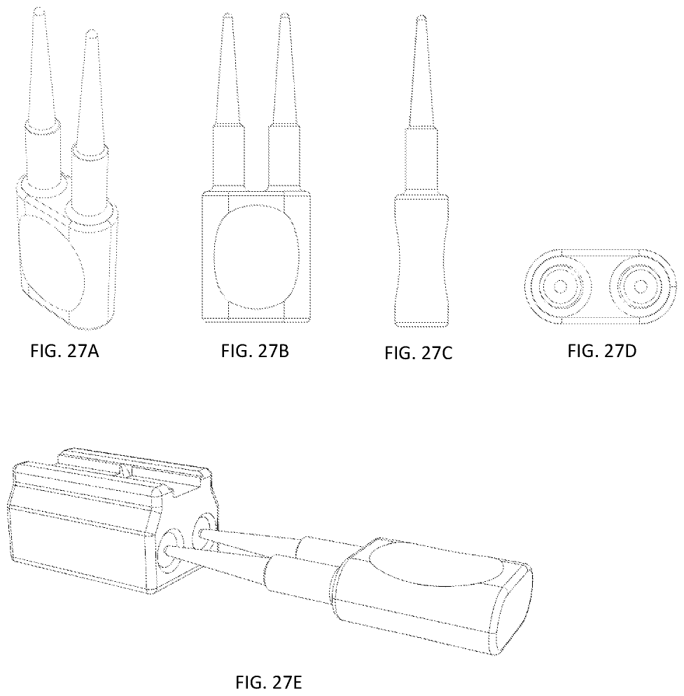

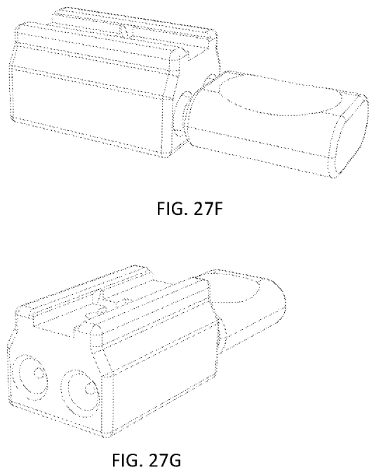

Assembly of the bit holder can easily be made by hand. To assist the “hold in place” step 4, above, an assembly tool, such as that shown in FIG. 27 may be used.

Users attach the bit holder to their power tool using 14. Users insert a bit or bits into any or all bores (8a, 11a). Each bore is capable of holding two (2) bits. Within each bore, both faces of 7 and 10 are exposed to their respective bores (8a, 11a) to provide magnetized inductor surface area for blunt end of bits to attach to. Bores (8a, 11a) act as a guide and housing for bits while bore chamfers (8b, 11b) assist the user's insertion of bits, especially those without chamfered blunt ends. Once in place, bits are held by an inducted and redirected magnetic field by magnetic inductors (7, 10) from the magnetic source that originates from magnet (15). Magnetic inductors (7, 10) provide mechanical isolation from the magnet (15), thus protecting it from potential damage.

Users retrieve bits from the device by pulling them from their respective bores (8a, 11a).

It will be appreciated that different combinations of magnets, inductors, and bores are possible, which will serve the same, equivalent function of the device. For example, the device is extensible by units of two (2), so that the four (4) bit capacity could be increased to six (6), eight (8), and so on, utilizing additional same magnet(s) or additional Halbach Arrays. FIGS. 28-47 show additional possible embodiments of the device of the invention.

Magnetic panel, or panels, may be added for storage or holding of fasteners, screws, washers, or any ferrous parts that the user may want providing their size is compatible with the magnetic panel's exposed size.

A person would install the device on their power tool and insert the bit(s) of their choice, and then, as the person's need changes while using their power tool, they may retrieve the newly needed bit and place it in the bit chuck of their power tool, thus eliminating the need for trips away from their work station or the place their work is being performed. This is more important if their immediate work location is in a remote location, such as up on a ladder or within a crawl space, and so on.

The device holds bits in a pattern that affords more space between bits so that a person wearing gloves while using their power tool may retrieve bits without the need to remove their gloves.

The device may be configured to retain specialized tools, bits, or other apparatus specific to an industry, sport, or endeavor where interchange of tools, bits, spares, or other apparatus may be needed that is proximate to the target need.

The foregoing is considered illustrative of the principles of the invention. As modifications and changes may occur to those skilled in the art, it is not desired to limit the invention to the exact construction and manner of use as shown and described. Rather, all suitable modifications and equivalents may be resorted to as falling within the scope of the invention as claimed.

What is claimed is:

1. A bit holder for a power tool, comprising:
a body having a plurality of holding bores extending along portions of the body;
a magnet disposed in the body;
a first magnetic inductor disposed at an end of the bore and in contact with a side of the magnet;
a second magnetic inductor disposed at an end of the bore and in contact with an opposing side of the magnet;
a mounting bore extending through the body.

2. The bit holder according to claim 1, wherein the body has a rectangular cuboid shape.

3. The bit holder according to claim 1, wherein the body has a cylindrical shape.

4. The bit holder according to claim 1, wherein the magnet is disposed in a slot in the body.

5. The bit holder according to claim 1, wherein the mounting bore extends essentially perpendicularly to a direction of the holding bores.

6. The bit holder according to claim 1, wherein a surface of the body is configured to be complimentary to a surface of the power tool.

7. The bit holder according to claim 1, wherein keyed mounting places the bit holder in a fixed position.
